(19) United States
(12) Patent Application Publication
(10) Pub. No.: US 2007/0124393 A1
(43) Pub. Date: May 31, 2007

(54) PRESENCE BASED NOTIFICATIONS

(75) Inventor: Stephane H. Maes, Fremont, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 11/383,817

(22) Filed: May 17, 2006

Related U.S. Application Data
(60) Provisional application No. 60/737,915, filed on Nov. 18, 2005.

(51) Int. Cl. G06F 15/16

(52) U.S. Cl. 709/206

(57) ABSTRACT

Systems, methods, and machine-readable media are disclosed for using past presence information to help determine a current presence of a user. In one embodiment, determining presence of a user on one or more devices or networks can comprise periodically querying a plurality of devices to determine a presence of the user on one or more of the plurality of devices. An indication of the presence of the user on the one or more of the plurality of devices can be received and presence information related to the indication of the presence of the user on the one or more devices can be stored. A request for a presence of the user can be received and, in response, the stored presence information can be retrieved. The stored presence information and, in some cases, current presence information can be provided in response to the request for the presence of the user.

### BACKGROUND OF THE INVENTION

Embodiments of the present invention relate generally to notifying a user on a device of a communication to or a request to communicate with that device and more particularly to using presence information to determine when and/or where to provide such a notification.

Presence can be defined as the technology and information that makes it possible to locate and identify a computing device wherever it might be, when it connects to a network. Presence is typically obtained by interrogating a service provided by a service provider to determine whether a particular device is currently present. Various systems and communications networks are able to provide current presence information related to users of those systems and/or networks. Today presence is typically available as part of another communication application like IM (Instant messaging), voice chat (e.g. SKYPE), video chat or push to Talk over cellular (PoC). For example, an IM client can detect presence based on keyboard activity etc. Similarly, a cellular or other telephone service can detect presence based on a condition of a telephone, e.g., the phone being “off-hook”.

However, such presence information is underutilized. That is, many types of communications are made without consideration of the presence of a device or user on a particular network. For example, push email servers and notification servers in general commonly push notifications of new or available emails or of other information update of interest and/or to which is subscribed to clients regardless of whether that client is able to receive the notification. If the targeted device is not available to receive the notification, the server simply resends the notification periodically until the device responds and downloads the available messages. However, if the device is disconnected from the network, out of the service coverage area, turned off, or otherwise unable to receive the message, this creates inefficiencies in the use of bandwidth and processing used by the server.

Hence, there is a need for methods and systems that allow for using presence information to determine when and/or where to provide notification of pending communications.

### BRIEF SUMMARY OF THE INVENTION

Systems, methods, and machine-readable media are disclosed for using presence information to determine when and/or where to provide a notification to a user on a device of a communication to or a request to communicate with that device. In one embodiment, a method of providing notification of a communication to an end device can comprise receiving a request to communicate with the end device. A presence of the end device on a communication network can be determined. In response to determining the end device is present on the communication network, a notification of the request to communicate with the end device can be sent. In response to determining the end device is not present on the network, an indication of the request to communicate with the end device can be saved. After saving the indication of the request to communicate with the end device, when the end device becomes available on the network, a notification of the request to communicate with the end device can be sent to the end device.

According to one embodiment, prior to sending the notification of the request to communicate with the end device, one or more presence attributes associated with the end device can be read. In such a case, sending the notification of the request to communicate with the end device can be based on the presence attributes. The presence attributes can include, for example, an indication of a notification channel that may be, in some cases, separate from the communication network. Sending the notification of the request to communicate with the end device can comprise sending the notification of the request to communicate with the end device via the notification channel. The notification of the request to communicate with the end device can comprise a Short Message Service (SMS) message, a Session Initiation Protocol (SIP) Notify message, a Wireless Application Protocol (WAP) Push message, an eXtensible Messaging and Presence Protocol (XMPP) message, or any other of a wide variety of types and/or formats.

According to another embodiment, a method of providing notification of a communication to a device can comprise detecting a communication directed to the device. A presence of the device on a first communication network can be determined. In response to determining the device is not present on the first communication network, an indication of the communication can be saved. In response to determining the device is present on the first network, a notification of the communication can be sent to the device.

The method can further comprise, prior to sending the notification of the communication to the device, reading one or more presence attributes associated with the device. In such a case, sending the notification of the communication to the device can be based on the presence attributes. The presence attributes can include, for example, an indication of a notification channel that may be, in some cases, on a second communication network. Sending the notification of the communication to the end device can comprise sending the notification of the communication to the end device via the notification channel.

In another case, after saving the indication of the communication, when the device becomes available on the first communication network, a notification of the communication can be sent to the device. Again, prior to sending the notification of the communication to the device, one or more presence attributes associated with the device can be read and sending the notification of the communication to the device can be based on the presence attributes. The presence attributes can include an indication of a notification channel which may be on a second communication network. Sending the notification of the communication to the end device can comprise sending the notification of the communication to the end device via the notification channel.

According to yet another embodiment, a system can comprise a first communication network, a client device communicatively coupled with the first communication network, and a presence server communicatively coupled with the first communication network and adapted to detect a presence of the client device on the first communication network. The system can also include a communication server communicatively coupled with the first communication network. The communication server can be adapted to detect a communication directed to the client device, request a presence status for the client device on the first communication network from the presence server, and in response to presence status indicating that the client device is not present on the first communication network, save an indication of the communication.

The communication server can be further adapted to, in response to the presence status indicating that the client device is present on the first network, send a notification of the communication to the client device. In some cases, the communication server can be further adapted to, prior to sending the notification of the communication to the client device, read from the presence server one or more presence attributes associated with the client device. In such a case, the communication server can be adapted to send the notification of the communication to the client device based on the presence attributes. For example, the presence attributes include an indication of a notification channel. The communication server can be adapted to send the notification of the communication to the client device via the notification channel. In some cases, the system can further comprise a second communication network, wherein the communication server and the client device are communicatively coupled with the second communication network. In such a case, the notification channel can be on the second communication network.

According to one embodiment, the presence server can be further adapted to detect a change of presence status for the client device and send an indication of the change of presence status for the client device to the communication server. In such a case, the communication server can be further adapted to, after saving the indication of the communication, receive the indication of the change of presence status for the client device from the presence server and send a notification of the communication to the client device. Again, the communication server can be adapted to, prior to sending the notification of the communication to the client device, read from the presence server one or more presence attributes associated with the client device. In such a case, the communication server can be adapted to send the notification of the communication to the client device based on the presence attributes. For example, the presence attributes can include an indication of a notification channel. The communication server can be adapted to send the notification of the communication to the client device via the notification channel. In some cases, the system can further comprise a second communication network, wherein the communication server and the client device are communicatively coupled with the second communication network. In such a case, the notification channel can be on the second communication network.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high level, a system for providing notifications of communications based on presence of a user on one or more devices according to one embodiment of the present invention.

FIG. 4 is a block diagram illustrating exemplary functional components of a system for providing notifications of communications based on presence of a user on one or more devices according to one embodiment of the present invention.

FIG. 5 is a flowchart illustrating a process for system for providing notifications of communications based on presence of a user on one or more devices according to one embodiment of the present invention.

FIG. 6 is a flowchart illustrating additional details of a process for system for providing notifications of communications based on presence of a user on one or more devices according to an alternative embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Embodiments of the present invention provide methods, system and machine-readable media for using presence information to determine when and/or where to provide notification of pending communications. Generally speaking, a method of providing notification of a communication to an end device can comprise receiving a request to communicate with the end device. A presence of the end device on a communication network can be determined. In response to determining the end device is present on the communication network, a notification of the request to communicate with the end device can be sent. In response to determining the end device is not present on the network, an indication of the request to communicate with the end device can be saved. After saving the indication of the request to communicate with the end device, when the end device becomes available on the network, a notification of the request to communicate with the end device can be sent to the end device.

Importantly, it should be noted that embodiments of the present invention may be implemented in a wide variety of environments and on a wide variety of devices and/or systems. Therefore, the following exemplary environments and systems are offered for illustrative purposes only and should not be considered limiting on the wide variety of possible implementation of the various embodiments of the present invention.

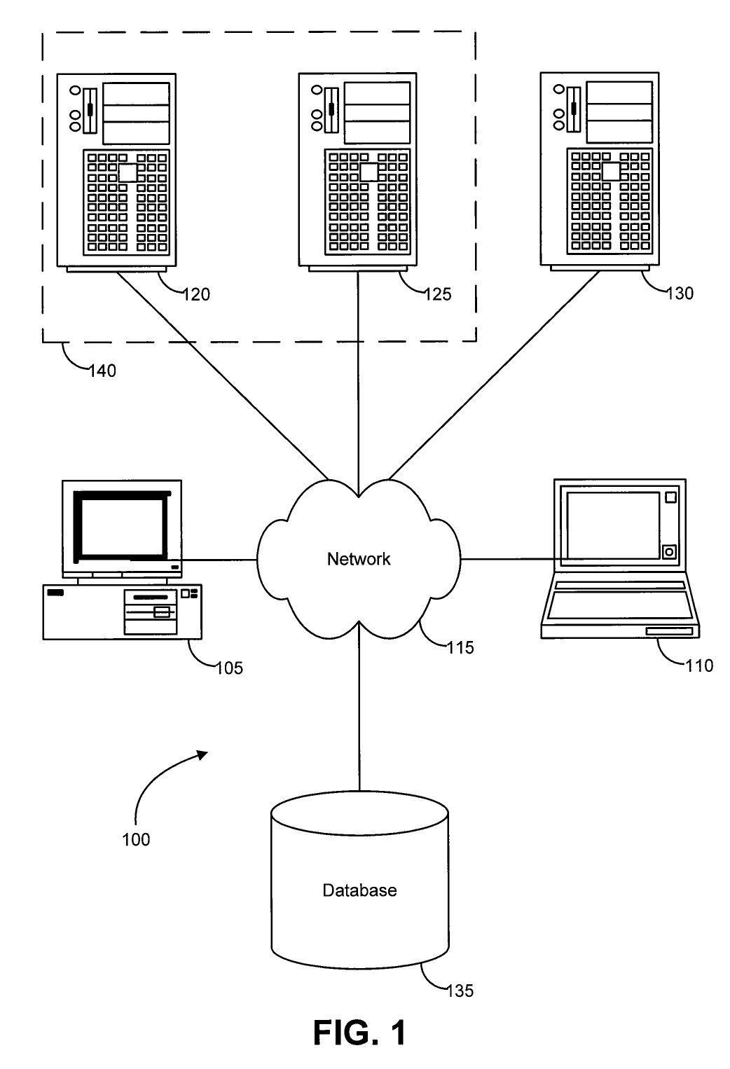

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GPRS, GSM, UMTS, EDGE, 2G, 2.5G, 3G, 4G, Wimax, WiFi, CDMA 2000, WCDMA, etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 1 10. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle, Microsoft, Sybase™, IBM™ and the like, which can process requests from database clients running on a user computer 105, 110.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

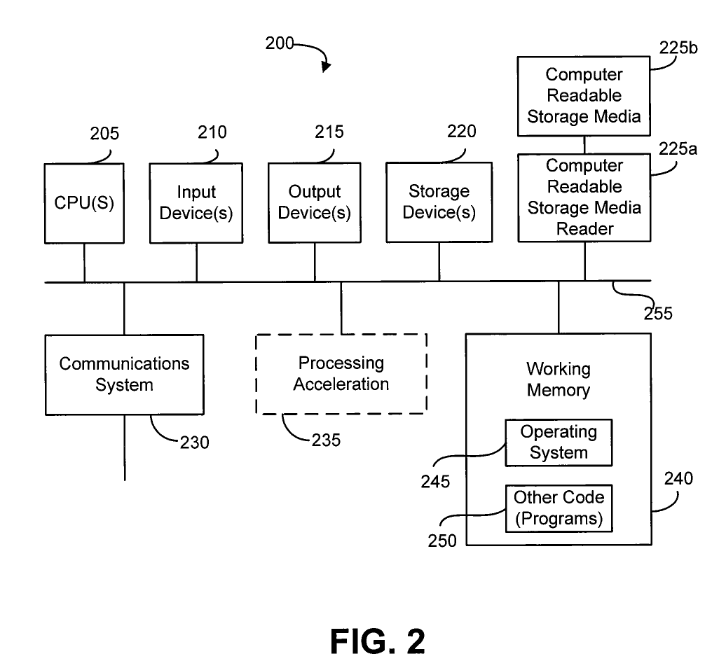

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235 , which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 400 may include code 450 for implementing processes for dynamically providing multimodal and/or multi-device configuration and support.

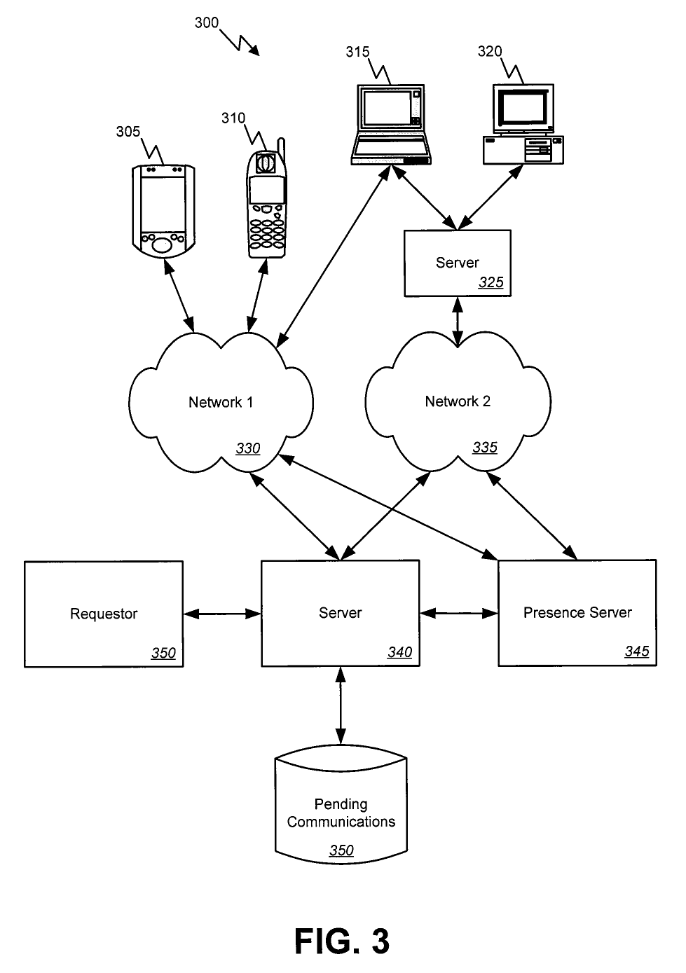

FIG. 3 is a block diagram illustrating, at a high level, a system for providing notifications of communications based on presence of a user on one or more devices according to one embodiment of the present invention. In this example, the system 300 includes a number of devices such as end devices 305-320. The devices 305-320 can be communicatively coupled with one or more networks 330 and 335 either directly or via one or more servers 335. Some devices 315 may in fact be coupled with or have the ability to be coupled with more than one network 330 and 335 either at the same or different times. Additionally, it should be noted that a wide variety of different device types and/or combination of device types may be used and embodiments of the present invention are not limited to use with any specific types of devices 305-320.

The system 300 can also include a presence server 345. While referred to herein as a server, it should be noted that presence server 345 may in fact be a presence server or any other device or application capable of determining presence of a user on one or more of the devices 305-320 and/or networks 330 and 335. Presence server 345 can be communicatively coupled with the one or more networks 330 and 335 and be used to determine a presence of a user on one or more of the devices 305-320 and/or networks 330 and 335.

The presence server 345 can also communicatively coupled with a communication server 340 such as an email server, communication gateway, web server, or other type of server or other type of device, application, etc. The communication server 340 may in turn be communicatively coupled with a requester 350 or client that initiates a communication or requests to initiate a communication with one of the devices 305-320. Alternatively or additionally, the requester or another such device may be communicatively coupled with the presence agent 345. In either case, the requester 350 or communication server 340, upon initiating or requesting to initiate a communication with one of the devices 305-320 of the system 300, can first check the presence of the device on one or more of the networks 303-335 by requesting presence information for that device from the presence server 345. If the device is found to be present, a notification of the pending communication can be sent to that device. If the device is not present, an indication of the communication or request can be saved, for example in a store 350 of pending communication information 350, until the device becomes available on one or more of the networks 330 and 335.

So, in use, the communication server 340 can be adapted to detect a communication directed to a client device 315. The communication, such as an email or other type of message, can originate from the requester 350 or from the communication server 340 itself. In either case, the communication server 340 can request a presence status for the client device 340 from the presence server 340. In response to the presence status indicating that the client device 315 is not present on the first communication network 335, an indication of the communication can be saved, for example, in the store 350 of pending communication information. Alternatively or additionally, a requester 350 may, in some cases request presence information from the presence server 345 directly, rather than through the communication server 340. In such a case, the requester may, In response to the presence status indicating that the client device 315 is not present on the first communication network 335, save an indication of the communication.

The communication server 340 and/or requester 350 can be further adapted to, in response to the presence status indicating that the client device 315 is present on the first network 335, send a notification of the communication to the client device 315. In some cases, the communication server 340 can be further adapted to, prior to sending the notification of the communication to the client device 315, read from the presence server 345 one or more presence attributes associated with the client device 315. In such a case, the communication server 340 can be adapted to send the notification of the communication to the client device 315 based on the presence attributes.

For example, the presence attributes can include an indication of a notification channel. The communication server 340 can be adapted to send the notification of the communication to the client device 315 via the notification channel. In some cases, the system can further comprise a second communication network 330, wherein the communication server 340 and the client device 315 are communicatively coupled with the second communication network 330. In such a case, the notification channel can be on the second communication network 330. So, for example, the target device 315 may be adapted to connect to multiple networks or to communication in various modes or via various formats. In such a case, presence attributes set by the user of the device or another and stored by the presence server 345, can be used to inform the communication server 340 or requestor 350 of a channel or manner in which to send a notification to the device 315. For example, the notification of the request to communicate with the end device can comprise a Short Message Service (SMS) message, a Session Initiation Protocol (SIP) Notify message, a Wireless Application Protocol (WAP) Push message, an eXtensible Messaging and Presence Protocol (XMPP) message, or any other of a wide variety of types and/or formats to be sent over any number of different types of networks or media.

According to one embodiment, the presence server 345 can be further adapted to detect a change of presence status for the client device 315 and send an indication of the change of presence status for the client device 315 to the communication server 340. In such a case, the communication server 340 can be further adapted to, after saving the indication of the communication, receive the indication of the change of presence status for the client device 315 from the presence server 345 and send a notification of the communication to the client device 315. That is, when the client device 315 becomes available on the network 335 and is detected by the presence server 345, the presence server can notify or inform the communication server 340 of this change in status.

Again, the communication server 340 can be adapted to, prior to sending the notification of the communication to the client device 315, read from the presence server 345 one or more presence attributes associated with the client device 315. In such a case, the communication server 340 can be adapted to send the notification of the communication to the client device 315 based on the presence attributes. For example, the presence attributes can include an indication of a notification channel. The communication server 340 can be adapted to send the notification of the communication to the client device 315 via the notification channel.

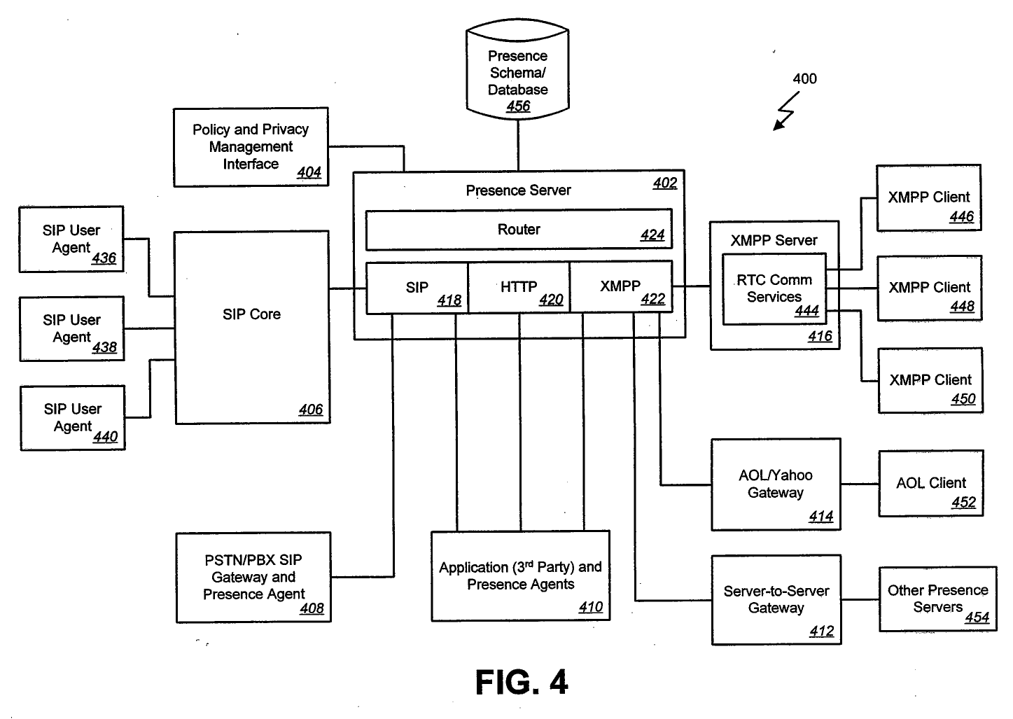

FIG. 4 is a block diagram illustrating exemplary functional components of a system for providing notifications of communications based on presence of a user on one or more devices according to one embodiment of the present invention. In this example, the system 400 includes a presence server 402. Again, while referred to herein as a server, it should be noted that presence server 402 may in fact be a presence server or any other device or application capable of determining presence of a user on one or more devices and/or networks. The presence server 402 can provide a number of different interface modules 418-422 including, but not limited to a Session Initiation Protocol (SIP) interface module 418, a HyperText Transfer Protocol (HTTP) interface module 420, and/or an eXtensible Messaging and Presence Protocol (XMPP) interface module 422. As will be seen, these and other possible interface modules 418-422 allow any number of other servers and/or user agents to communicate with the presence server 402 and request and/or receive presence information.

The presence server 402 can also include a router 424 for directing communications to, from or through the presence server 402 in conventional manners. Also, the presence server 402 can be coupled with or include a presence schema or database 456 for storing presence information and a policy and privacy management interface 404 for providing access to and configuration of various policies for accessing and/or maintaining the presence service and/or presence information. Importantly, while illustrated here as separate from the presence server 402, it should be understood that either or both of the policy and privacy management interface and/or the presence schema/database 456 may, in different implementations, be part of or maintained within the same equipment providing the functions of the presence server 402.

The presence server 402 can be also communicatively coupled with any number of servers, agents, or other devices via the interface modules 418-422. For example, the presence server 402 can be communicatively coupled with a SIP core 406, a PSTN or PBX gateway and/or presence agent 408, third party applications 410, a server-to-server gateway 412, an AOL or Yahoo gateway 414, a, XMPP server 416, etc. Each of these other servers, agents, and/or devices 406-418 may in turn be communicatively coupled with one or more user agents and/or clients. So, for example, a number of SIP user agents 436-440 may be in communication with the SIP core 406 while a number of XMPP clients 446-450 may be in communication with the XMPP server 416. Similarly, a number of clients 452 may communicate with the AOL or Yahoo gateway 414 while a number of other presence servers 454 may communicate with the server-to-server gateway 412.

Therefore, through this system 400, the presence server 402 can collect presence information about any or all of the other elements of the system and distribute this presence information to other elements of the system in the conventional manner either periodically or upon request. So, for example, the SIP core 406 can be adapted to detect a communication directed to another device or server in the system 400 such as an XMPP client 446. The SIP core can request a presence status for the XMPP client 446 from the presence server 402. In response to the presence status indicating that the XMPP client 446 is not present, an indication of the communication can be saved by the SIP core. The SIP core 406 can be further adapted to, in response to the presence status indicating that the XMPP client 446 is present, send a notification of the communication to the XMPP client 446. That is, any of the server, devices, agents, etc. of the system can use the presence information of the presence server 402 to determine when and where to send notification of a communication to a particular device as described above and as will be described below.

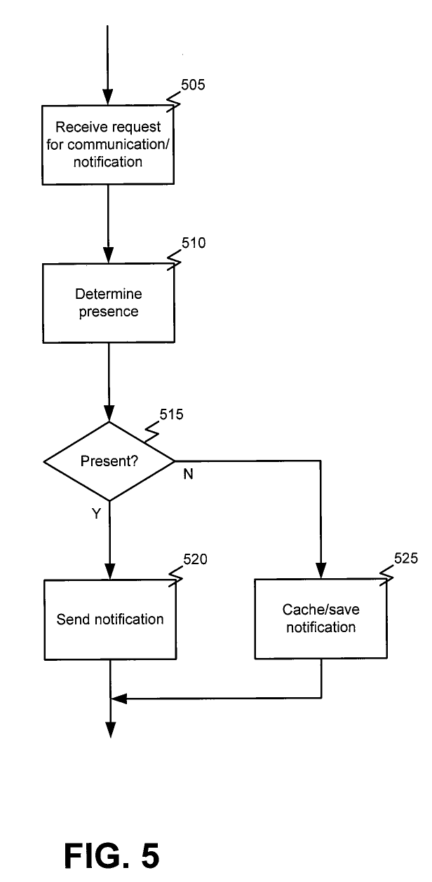

FIG. 5 is a flowchart illustrating a process for system for providing notifications of communications based on presence of a user on one or more devices according to one embodiment of the present invention. In this example, processing begins with receiving 505 a request to communicate with the end device or otherwise detecting a pending communication with the client device. For example, an email server may receive an email to be delivered to the client device. In another case, a server may initiate a communication of some other type based on the occurrence of some other event or satisfaction of some other condition. For example, a web service or other server may, upon the occurrence of some calendar event, initiate a communication to the client device to inform the user of the event.

Once the request for communication is received or detected, a presence of the end device on a communication network can be determined 510. That is, the server or other requester can query the presence server and receive in return a status of the client device. That is the presence server can return a “present” condition, a “not present” condition, and “unknown” condition, or some other condition indicating the status of the client device. Alternatively, rather than querying the presence server, presence information can be provided by the presence server periodically or whenever the condition of the client device changes. Such information can be saved by the communication server and/or requester for use when communicating with that device.

Based on the information from the presence server, obtained in real time or from saved information, a determination 515 can be made as to whether the device is present on the communication network. In response to determining 515 the end device is present on the communication network, a notification of the request to communicate with the end device can be sent 520. In response to determining 515 the end device is not present on the network, an indication of the request to communicate with the end device can be saved 525.

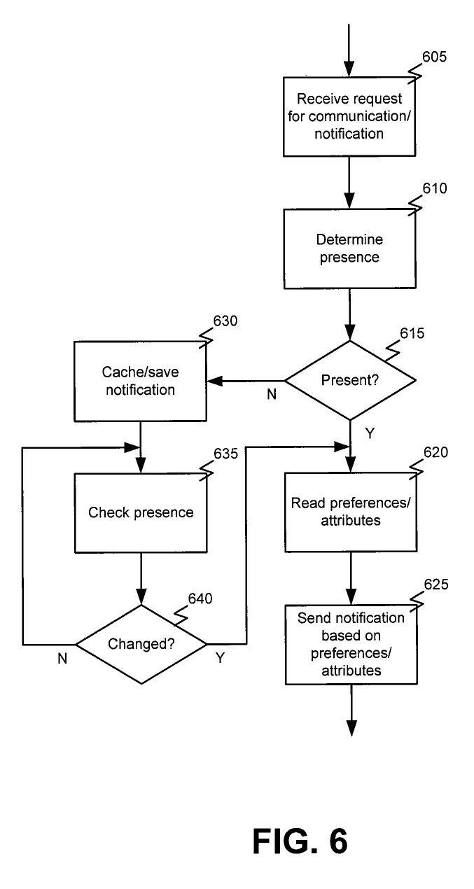

FIG. 6 is a flowchart illustrating additional details of a process for system for providing notifications of communications based on presence of a user on one or more devices according to an alternative embodiment of the present invention. In this example, processing begins with receiving 605 a request to communicate with the end device or otherwise detecting a pending communication with the client device. For example, an email server may receive an email to be delivered to the client device. In another case, a server may initiate a communication of some other type based on the occurrence of some other event or satisfaction of some other condition. For example, a web service or other server may, upon the occurrence of some calendar event, initiate a communication to the client device to inform the user of the event.

In any case, once the request for communication is received or detected, a presence of the end device on a communication network can be determined 610. That is, the server or other requester can query the presence server and receive in return a status of the client device. That is the presence server can return a “present” condition, a “not present” condition, and “unknown” condition, or some other condition indicating the status of the client device. Alternatively, rather than querying the presence server, presence information can be provided by the presence server periodically or whenever the condition of the client device changes. Such information can be saved by the communication server and/or requester for use when communicating with that device.

Based on the information from the presence server, obtained in real time or from saved information, a determination 615 can be made as to whether the device is present on the communication network. In response to determining 615 the end device is present on the communication network, one or more presence attributes associated with the device can be read 620 from the presence server and the request to communicate with the end device can be sent 625. As noted above, sending 625 the notification of the communication to the device can be based on the presence attributes. The presence attributes can include, for example, an indication of a notification channel that may be, in some cases, on a second communication network. Sending 625 the notification of the communication to the end device can comprise sending 625 the notification of the communication to the end device via the notification channel.

In response to determining 615 the end device is not present on the network, an indication of the request to communicate with the end device can be saved 630. Then, according to one embodiment, the presence of the device can be periodically checked 635 via the presence server. Alternatively, rather than periodically querying the presence server, the presence server can provide a real-time or near real-time notification of a change in status of the device. In either case, once a determination 640 is made that the device is now present on the network, i.e., one or more presence attributes associated with the device can be read 620 and the notification of the communication can be sent 625 to the device can be based on the presence attributes. The presence attributes can include an indication of a notification channel which may be on a second communication network. Sending 625 the notification of the communication to the end device can comprise sending the notification of the communication to the end device via the notification channel.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method of providing notification of a communication to an end device, the method comprising:
receiving a request to communicate with the end device;
determining a presence of the end device on a communication network;
in response to determining the end device is present on the communication network, sending a notification of the request to communicate with the end device; and
in response to determining the end device is not present on the network, saving an indication of the request to communicate with the end device.

2. The method of claim 1, further comprising, after saving the indication of the request to communicate with the end device, detecting the end device becoming available on the network and sending a notification of the request to communicate with the end device to the end device.

3. The method of claim 1, further comprising prior to sending the notification of the request to communicate with the end device, reading one or more presence attributes associated with the end device.

4. The method of claim 3, wherein sending the notification of the request to communicate with the end device is based on the presence attributes.

5. The method of claim 3, wherein the presence attributes include an indication of a notification channel.

6. The method of claim 5, wherein the notification channel is separate from the communication network.

7. The method of claim 5, wherein sending the notification of the request to communicate with the end device comprises sending the notification of the request to communicate with the end device via the notification channel.

8. The method of claim 1, wherein the notification of the request to communicate with the end device comprises a Short Message Service (SMS) message.

9. The method of claim 1, wherein the notification of the request to communicate with the end device comprises a Session Initiation Protocol (SIP) Notify message.

10. The method of claim 1, wherein the notification of the request to communicate with the end device comprises a Wireless Application Protocol (WAP) Push message.

11. The method of claim 1, wherein the notification of the request to communicate with the end device comprises an extensible Messaging and Presence Protocol (XMPP) message.

12. A method of providing notification of a communication to a device, the method comprising:
detecting a communication directed to the device;
determining a presence of the device on a first communication network; and
in response to determining the device is not present on the first communication network, saving an indication of the communication.

13. The method of claim 12, further comprising in response to determining the device is present on the first network, sending a notification of the communication to the device.

14. The method of claim 13, further comprising prior to sending the notification of the communication to the device, reading one or more presence attributes associated with the device.

15. The method of claim 14, wherein sending the notification of the communication to the device is based on the presence attributes.

16. The method of claim 14, wherein the presence attributes include an indication of a notification channel.

17. The method of claim 16, wherein the notification channel is on a second communication network.

18. The method of claim 16, wherein sending the notification of the communication to the end device comprises sending the notification of the communication to the end device via the notification channel.

19. A method of claim 12, further comprising, after saving the indication of the communication, detecting the device becoming available on the first communication network and sending a notification of the communication to the device.

20. The method of claim 19, further comprising prior to sending the notification of the communication to the device, reading one or more presence attributes associated with the device.

21. The method of claim 20, wherein sending the notification of the communication to the device is based on the presence attributes.

22. The method of claim 20, wherein the presence attributes include an indication of a notification channel.

23. The method of claim 22, wherein the notification channel is on a second communication network.

24. The method of claim 22, wherein sending the notification of the communication to the end device comprises sending the notification of the communication to the end device via the notification channel.

25. A system comprising:
a first communication network;
a client device communicatively coupled with the first communication network;
a presence server communicatively coupled with the first communication network and adapted to detect a presence of the client device on the first communication network; and
a communication server communicatively coupled with the first communication network and adapted to detect a communication directed to the client device, request a presence status for the client device on the first communication network from the presence server, and in response to presence status indicating that the client device is not present on the first communication network, saving an indication of the communication.

26. The system of claim 25, wherein the communication server is further adapted to, in response to the presence status indicating that the client device is present on the first network, send a notification of the communication to the client device.

27. The system of claim 26, wherein the communication server is further adapted to, prior to sending the notification of the communication to the client device, read from the presence server one or more presence attributes associated with the client device.

28. The system of claim 27, wherein the communication server is adapted to send the notification of the communication to the client device based on the presence attributes.

29. The system of claim 27, wherein the presence attributes include an indication of a notification channel.

30. The system of claim 29, further comprising a second communication network, wherein the communication server and the client device are communicatively coupled with the second communication network and wherein the notification channel is on the second communication network.

31. The system of claim 29, wherein the communication server is adapted to send the notification of the communication to the client device via the notification channel.

32. The method of claim 25, wherein the presence server is further adapted to detect a change of presence status for the client device and send an indication of the change of presence status for the client device to the communication server.

33. The system of claim 32, wherein the communication server is further adapted to, after saving the indication of the communication, receive the indication of the change of presence status for the client device from the presence server and send a notification of the communication to the client device.

34. The system of claim 33, wherein the communication server is further adapted to, prior to sending the notification of the communication to the client device, read from the presence server one or more presence attributes associated with the client device.

35. The system of claim 34, wherein the communication server is adapted to send the notification of the communication to the client device based on the presence attributes.

36. The system of claim 34, wherein the presence attributes include an indication of a notification channel.

37. The system of claim 36, further comprising a second communication network, wherein the communication server and the client device are communicatively coupled with the second communication network and wherein the notification channel is on the second communication network.

38. The system of claim 37, wherein the communication server is adapted to send the notification of the communication to the client device via the notification channel.
